(19) United States
(12) Patent Application Publication
(10) Pub. No.: US 2016/0190973 A1
(43) Pub. Date: Jun. 30, 2016

(54) MOTOR DRIVE APPARATUS AND POWER STEERING APPARATUS

(71) Applicant: TOYOTA JIDOSHA KABUSHIKI KAISHA, Toyota-shi (JP)

(72) Inventor: Kenji TAMURA, Nissin-shi (JP)

(21) Appl. No.: 14/939,742

(22) Filed: Nov. 12, 2015

(30) Foreign Application Priority Data
Dec. 26, 2014 (JP) 2014-266324

(51) Int. Cl. H02P 29/02; B62D 5/04; H02P 21/00

(52) U.S. Cl. CPC H02P 29/022; H02P 21/0035; B62D 5/0457

(57) ABSTRACT

A disclosed motor drive apparatus includes a boost converter circuit, a first switch provided between the midpoint of the first upper and lower arms and the power supply, a first connection line connecting the power supply to an output part of the boost converter circuit, motor drive circuits provided for respective phases of a multi-phase motor, a second connection line connecting the output of the boost converter circuit to the respective second upper and lower arms of the motor drive circuits, second switches provided for the respective phases of the multi-phase motor, the second switches each selectively connecting the multi-phase motor to either midpoints of the second upper and lower arms of the corresponding phases or the midpoint of the first upper and lower arms; and a controller controlling the first switch and the second switches.

### CROSS REFERENCE TO RELATED APPLICATION

The present application is based on and claims the benefit of priority of Japanese Priority Application No. 2014-266324, filed on Dec. 26, 2014, the entire contents of which are hereby incorporated by reference.

### FIELD

This disclosure is related to a motor drive apparatus and a power steering apparatus.

### BACKGROUND

A backup operation device of a matrix converter is known from Japanese Laid-open Patent Publication No. 2008-172925. The backup operation device includes: a backup DC power supply, and a backup semiconductor switch group for one phase of an input phase, wherein the backup DC power supply is connected to a point between the input phase of one phase other than the input phase in which a failure is detected and an input of the backup semiconductor switch group when the failure is detected, and the semiconductor switch, which is connected to the input phase to which a direct current is fed, is turned on and off, and all the other semiconductor switches are turned off.

However, according to a configuration disclosed in Japanese Laid-open Patent Publication No. 2008-172925, the backup DC power supply and the backup semiconductor switch group are not used unless a failure is detected in the input phase, which leads to a problem that a circuit configuration is not efficient.

Therefore, an object of the present disclosure is to disclose a motor drive apparatus, etc., that implements an efficient circuit configuration that enables driving a motor even at a time of an abnormality in a boost converter circuit, while the boost converter circuit, which enables stepping up a voltage to be supplied to motor drive circuits, can be utilized as backup for the motor drive circuits.

### SUMMARY

According one aspect, a motor drive apparatus is disclosed, which includes:

a boost converter circuit including a coil and first upper and lower arms, one end of the coil being connected to a midpoint of the first upper and lower arms, the other end of the coil being connected to a power supply;

a first switch provided between the midpoint of the first upper and lower arms and the power supply, the first switch being connected to the coil in series;

a first connection line connecting the power supply to an output part of the boost converter circuit without passing through the first switch;

a limiting element provided on the first connection line, the limiting element limiting a flow of a current from the output part of the boost converter circuit to the power supply;

a plurality of motor drive circuits provided for respective phases of a multi-phase motor, the motor drive circuits each including second upper and lower arms;

a second connection line connecting the output of the boost converter circuit to the respective second upper and lower arms of the motor drive circuits;

a plurality of second switches provided, for the respective phases of the multi-phase motor, between the second upper and lower arms of the corresponding phases and the multi-phase motor, the second switches each selectively connecting the multi-phase motor to either midpoints of the second upper and lower arms of the corresponding phases or the midpoint of the first upper and lower arms; and a controller controlling the first switch and the second switches.

### BRIEF DESCRIPTION OF DRAWINGS

FIG. 1 is a diagram schematically illustrating a configuration of a system 1 including a motor drive apparatus 6 according to an example.

FIG. 2 is a diagram illustrating an alternative example of second switches 71, 72 and 73.

FIG. 3 is a diagram illustrating an example of a control system of a switch control part 92.

FIG. 4 is a flowchart illustrating an example of a process executed by a controller 9.

FIG. 5 is a diagram schematically illustrating a configuration of a system 1A including a motor drive apparatus 6A according to another example.

FIG. 6 is a diagram schematically illustrating a configuration of a system 1B including a motor drive apparatus 6B according to yet another example.

FIG. 7 is a diagram schematically illustrating a configuration of a system 1C including a motor drive apparatus 6C according to yet another example.

FIG. 8 is a diagram schematically illustrating a configuration of a system 1D including a motor drive apparatus 6D according to yet another example.

### DESCRIPTION OF EMBODIMENTS

In the following, embodiments are described in detail with reference to appended drawings.

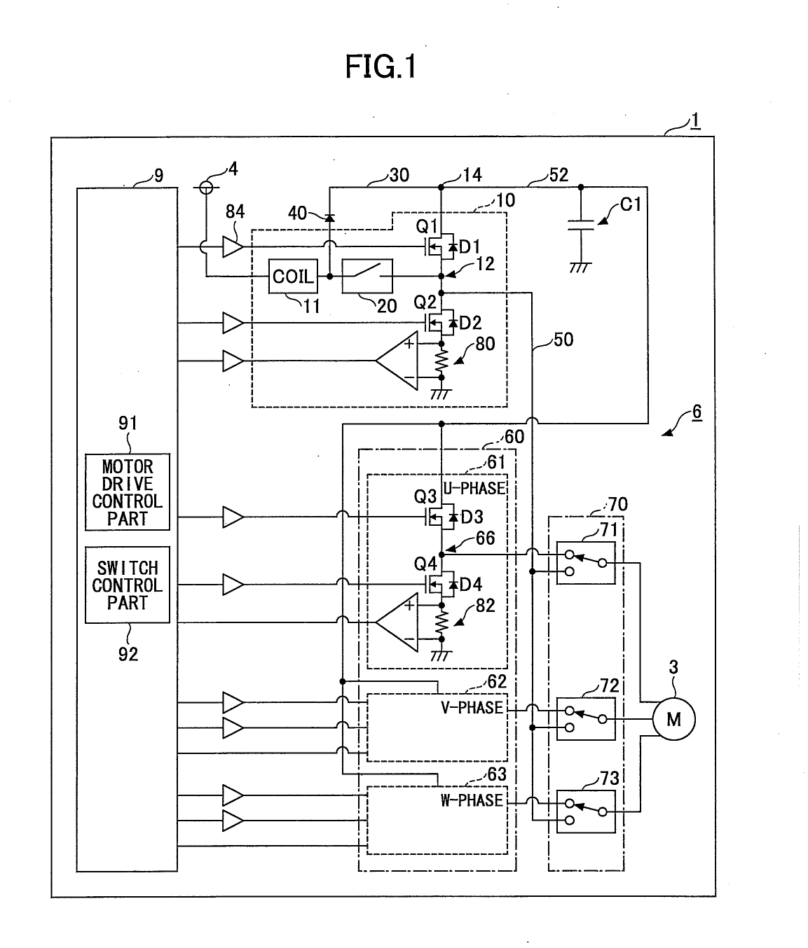

FIG. 1 is a diagram schematically illustrating a configuration of a system 1 including a motor drive apparatus 6 according to an example.

The system 1 is installed on a vehicle. Preferably, the vehicle is of a type that is commercially used and has a relatively great carrying capacity. This is because, in the case of such a type of the vehicle that is used commercially, in order to consider overloading, the necessity of increasing an output of a multi-phase motor 3 described hereinafter is high.

The system 1 includes the multi-phase motor 3, a power supply 4, and a motor drive apparatus 6.

The multi-phase motor 3 is a three-phase motor in the example illustrated in FIG. 1. For example, the multi-phase motor 3 generates assist torque (assist force) for assisting steering torque of a driver. In this case, the multi-phase motor 3 and the motor drive apparatus 6 form a power steering apparatus. In the following, as an example, it is assumed that the multi-phase motor 3 is an assist motor for generating the assist torque.

The power supply 4 is a DC power supply, for example. Here, the power supply 4 means a battery installed in the vehicle.

The motor drive apparatus 6 includes a controller 9, a boost converter circuit 10, a first switch 20, a first connection line 30, a diode 40 (an example of a limiting element), a motor drive line 50, a second connection line 52, a motor drive circuit part 60, and a second switch part 70.

The controller 9 may include a processor including a CPU, such as a microcomputer. The respective functions of the controller 9 (including functions described hereinafter) may be implemented by hardware, software, firmware or a combination thereof. For example, a part of or all of a function of the controller 9 may be implemented by an ASIC (application-specific integrated circuit). Further, the controller 9 may be implemented by a single processing device or a plurality of processing devices.

The controller 9 includes a motor drive control part 91, and a switch control part 92.

The motor drive control part 91 controls the boost converter circuit 10 and the motor drive circuit part 60 to control the multi-phase motor 3. In the example illustrated in FIG. 1, the motor drive control part 91 is connected to gates of respective switching elements, such as switching elements Q3, Q4, etc., via a pre-driver 84, and the motor drive control part 91 is connected to current sensors 80, 82. It is noted that the pre-driver 84 may be incorporated in the controller 9. The motor drive control part 91 controls respective switching operations of switching elements Q1, Q2 of the boost converter circuit 10, and the switching elements Q3, Q4, etc., of the motor drive circuit part 60, according to detection results of the current sensors 80, 82.

The motor drive control part 91 determines a target value related to the assist torque to be generated by the multi-phase motor 3, based on steering torque, vehicle speed, etc., for example. The target value related to the assist torque may be in form of a physical quantity, such as a current, a voltage, etc. For example, the target value related to the assist torque may be an assist motor current value (motor drive duty) to be applied to the multi-phase motor 3. For example, the target value related to the assist torque may be determined such that the assist torque increases as the steering torque of the driver increases, and the assist torque at higher vehicle speed is smaller than that at lower vehicle speed. Further, the value of the assist motor current to be applied to the multi-phase motor 3 may be feedback-controlled based on an output signal of a rotation angle sensor (not illustrated) that detects a rotation angle of the multi-phase motor 3 (i.e., a rotation angle of a rotor).

The motor drive control part 91 determines a target value of an output voltage of the boost converter circuit 10, and controls the boost converter circuit 10 (i.e., the switching elements Q1, Q2) such that the output voltage of the boost converter circuit 10 is equal to the target value. The target value of the output voltage of the boost converter circuit 10 may be a fixed value (greater than the voltage of the power supply 4). For example, at the time of a stepping up operation, the motor drive control part 91 switches on/off only the switching element Q2 of the lower arm of the boost converter circuit 10 to step up the voltage of the power supply 4. In this case, the switching element Q2 of the lower arm may be controlled with PMW (Pulse Width Modulation). It is noted that when the switching element Q2 of the lower arm is turned on, a loop of a current flowing from the power supply 4 to the ground via a coil 11 and the switching element Q2 is formed, which causes the current (reactor current) flowing through the coil 11 to increase. Next, when the switching element Q2 of the lower arm is turned off, the coil 11 causes the current to continue to flow therethrough, which causes the current to flow to an output part 14 via a diode D1 of the upper arm. In this manner, the stepping up operation is implemented. It is noted that the diode 40 on the first connection line 30, described hereinafter, has a function of preventing the current from flowing reversely at the time of the stepping up operation.

The switch control part 92 controls the first switch 20 and the second switch part 70 (i.e., second switches 71 through 73) of the motor drive apparatus 6 described hereinafter. A function of the switch control part 92 is described hereinafter.

The boost converter circuit 10 includes the coil (reactor) 11 and first upper and lower arms 12.

The coil 11 has one end connected to a midpoint of the first upper and lower arms 12 and the other end connected to the power supply 4. It is noted that the midpoint of the upper and lower arms such as the midpoint of the first upper and lower arms 12 means a point between a switching element of an upper arm and a switching element of a lower arm.

The first upper and lower arms 12 include two switching elements Q1, Q2 connected in series. The switching elements Q1, Q2 may be transistors, such as MOSFETs (Metal Oxide Semiconductor Field Effect Transistors), IGBTs (Insulated Gate Bipolar Transistors), etc. Preferably, the switching elements Q1, Q2 are of the same type (characteristic) as the switching elements Q3, Q4 of second upper and lower arms 66 described hereinafter. It is noted that, in the example illustrated in FIG. 1, the switching elements Q1, Q2 are n-type MOSFETs. Diodes D1, D2 are connected to the switching elements Q1, Q2 in parallel, respectively. Specifically, the diode D1 is provided between a source and a drain of the switching element Q1 for the current flowing from the source to the drain, and the diode D2 is provided between a source and a drain of the switching element Q2 for the current flowing from the source to the drain.

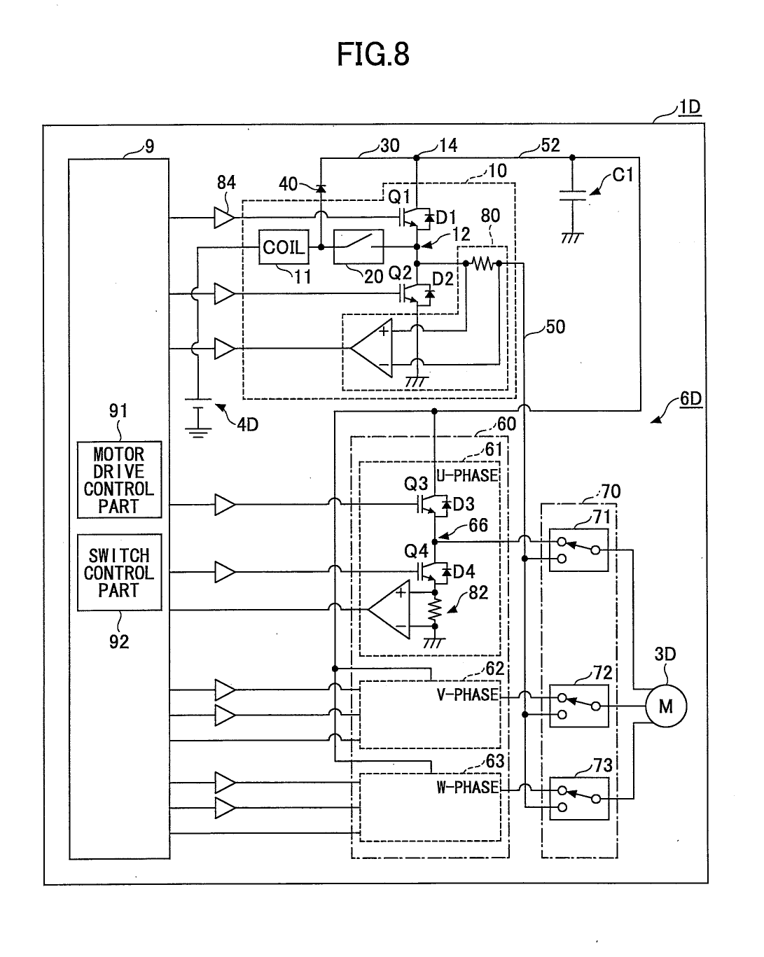

It is noted that, in the example illustrated in FIG. 1, the current sensor 80 is provided between the switching element Q2 of the lower arm and ground. The current sensor 80 may include a shunt resistor and a differential amplifier, as illustrated in FIG. 1. The current sensor 80 detects the current flowing through the first upper and lower arms 12 (i.e., the current flowing between the switching element Q2 of the lower arm and ground). However, the current sensor 80 may be provided between the switching element Q1 of the upper arm and the output part 14 of the boost converter circuit 10, or the current sensor 80 may be provided in the motor drive line 50 (see FIG. 8).

The boost converter circuit 10 generates, at the output part 14, an output voltage by stepping up the power supply voltage of the power supply 4 (the stepping up operation). It is noted that the output part 14 of the boost converter circuit 10 is formed on the drain side of the switching element Q1 in the case where the switching element Q1 of the upper arm is the n-type MOSFET.

The first switch 20 is provided between the midpoint of the first upper and lower arms 12 of the boost converter circuit 10 and the power supply 4, and connected to the coil 11 in series. In the example illustrated in FIG. 1, the first switch 20 is provided between the coil 11 and the midpoint of the first upper and lower arms 12 of the boost converter circuit 10. The first switch 20 may be a semiconductor switch or a mechanical relay. In the example illustrated in FIG. 1, the first switch 20 is a relay with a single arbeit contact.

The first connection line 30 connects the power supply 4 to the output part 14 of the boost converter circuit 10 not via the first switch 20. In other words, the first switch 20 is provided at a location where the first switch 20 in its closed state does not prevent the current from flowing from the power supply 4 to the first connection line 30. In the example illustrated in FIG. 1, the first connection line 30 connects a point between the coil 11 and the first switch 20 to the output part 14 of the boost converter circuit 10.

The diode 40 is provided in the first connection line 30. The diode 40 limits the flow of the current from the output part 14 of the boost converter circuit 10 to the power supply 4. In other words, a forward direction of the diode 40 corresponds to a direction from the power supply 4 to the output part 14.

The motor drive line 50 is formed from the midpoint of the first upper and lower arms 12. The motor drive line 50 connects the midpoint of the first upper and lower arms 12 to respective phases of the multi-phase motor 3 via the second switch part 70.

The second connection line 52 connects the output part 14 of the boost converter circuit 10 to the respective second upper and lower arms 66 of motor drive circuits 61, 62, 63. The second connection line 52 is connected to upper arms of the respective second upper and lower arms 66 of the motor drive circuits 61, 62, 63. For example, in the case where the switching element Q3 of the upper arm is the n-type MOSFET, the second connection line is connected to drains of the MOSFETs of the second upper and lower arms 66 of the respective motor drive circuits 61, 62, 63. A smoothing capacitor C1 may be provided in the second connection line 52. The smoothing capacitor C1 has the output voltage of the boost converter circuit 10 smoothed.

The motor drive circuit part 60 includes the motor drive circuits 61, 62, 63. The motor drive circuits 61, 62, 63 are provided for the respective phases of the multi-phase motor 3 to form an inverter circuit. Specifically, the motor drive circuit 61 corresponds to a U-phase, the motor drive circuit 62 corresponds to a V-phase, and the motor drive circuit 63 corresponds to a W-phase. It is noted that, in FIG. 1, configurations in the motor drive circuits 62, 63 are omitted; however, the motor drive circuits 62, 63 have the same configurations as the motor drive circuit 61.

The motor drive circuits 61, 62, 63 each include the second upper and lower arms 66. The second upper and lower arms 66 include two switching elements Q3, Q4 connected in series. The switching elements Q3, Q4 may be transistors such as MOSFETs, IGBTs, etc. It is noted that, in the example illustrated in FIG. 1, the switching elements Q3, Q4 are n-type MOSFETs. Diodes D3, D4 are connected to the switching elements Q3, Q4 in parallel, respectively.

It is noted that, in the example illustrated in FIG. 1, the current sensors 82 are provided between the switching elements Q4 of the lower arms and ground, respectively. Each current sensor 82 may include a shunt resistor and a differential amplifier, as illustrated in FIG. 1. Each current sensor 82 detects the current flowing through the second upper and lower arms 66 (i.e., the current flowing between the switching element Q4 of the lower arm and ground).

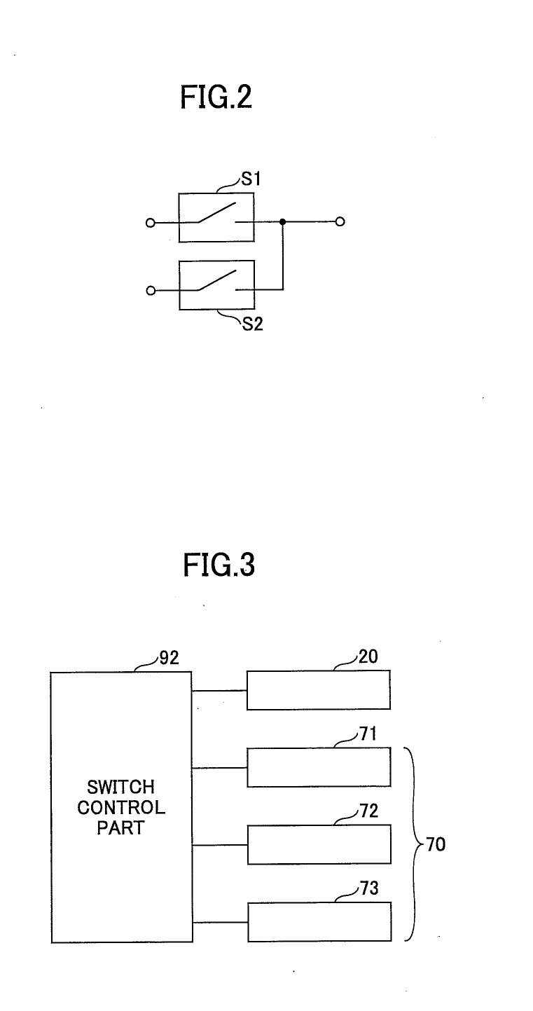

The second switch part 70 includes a plurality of second switches 71, 72, 73. The second switches 71, 72, 73 each may be relays with single C contacts (transfer contacts), as illustrated in FIG. 1. Alternatively, the second switches 71, 72, 73 each may be relays with two combined arbeit contacts S1 and S2, as illustrated in FIG. 2. Alternatively, the second switches 71, 72, 73 each may be MBB (Make-Before-Break) contacts. It is noted that the MBB contact has the same configuration as the C contact, but the MBB contact is switched via a state in which the arbeit contact and a break contact are conducting.

The second switches 71, 72, 73 are provided for the phases of the multi-phase motor 3, respectively. Specifically, the second switch 71 is provided between the midpoint of the second upper and lower arms 66 related to U-phase and the multi-phase motor 3. The second switch 71 selectively connects the multi-phase motor 3 to either the midpoint of the second upper and lower arms 66 related to U-phase or the midpoint of the first upper and lower arms 12 (i.e., the motor drive line 50). The second switch 72 is provided between the midpoint of the second upper and lower arms 66 related to V-phase and the multi-phase motor 3. The second switch 72 selectively connects the multi-phase motor 3 to either the midpoint of the second upper and lower arms 66 related to V-phase or the midpoint of the first upper and lower arms 12 (i.e., the motor drive line 50). The second switch 73 is provided between the midpoint of the second upper and lower arms 66 related to W-phase and the multi-phase motor 3. The second switch 73 selectively connects the multi-phase motor 3 to either the midpoint of the second upper and lower arms 66 related to W-phase or the midpoint of the first upper and lower arms 12 (i.e., the motor drive line 50).

According to the example illustrated in FIG. 1, as described above, the output part 14 of the boost converter circuit 10 is connected to the second upper and lower arms 66 of the respective motor drive circuits 61, 62, 63 via the second connection line 52. Thus, the boost converter circuit 10 can step up the supply voltage to be applied to the motor drive circuits 61, 62, 63. Therefore, the motor drive circuits 61, 62, 63 can drive the multi-phase motor 3 based on the output voltage of the boost converter circuit 10 that is higher than the power supply voltage of the power supply 4. As a result of this, increasing the output of the multi-phase motor 3 is promoted. It is noted that increasing the output of the multi-phase motor 3 can be implemented by increasing the supply current without stepping up the power supply voltage. However, loss is proportional to the square of the current, and thus increasing the output of the multi-phase motor 3 by stepping up the power supply voltage is more advantageous than increasing the output of the multi-phase motor 3 by increasing the supply current in terms of the loss.

It is noted that increasing the output of the multi-phase motor 3 is useful, in particular, when the vehicle is of a type that is commercially used and has a relatively great carrying capacity, as described above.

Further, according to the example illustrated in FIG. 1, as described above, the first connection line 30 is connected to the output part 14 of the boost converter circuit 10, which enables outputting the power supply voltage (not stepped up) of the power supply 4 to the output part 14 of the boost converter circuit 10 via the first connection line 30 by opening the first switch 20. Thus, it is also possible to supply the power supply voltage of the power supply 4 to the boost converter circuit 10 and the motor drive circuits 61, 62, 63. Further, according to the example illustrated in FIG. 1, as described above, it is possible to selectively connect the midpoint of the boost converter circuit 10 to any phase of the multi-phase motor 3 via the motor drive line 50 and the second switch part 70. With this arrangement, it is also possible to utilize the boost converter circuit 10 as the backup for the motor drive circuits 61, 62, 63. For example, when the motor drive circuit 61 related to U-phase has an abnormality, the boost converter circuit 10 can implement the function of the motor drive circuit 61 by opening the first switch 20 and connecting the midpoint of the boost converter circuit 10 to U-phase of the multi-phase motor 3. In this way, according to the example illustrated in FIG. 1, an efficient circuit configuration is implemented so that the boost converter circuit 10, which enables stepping up the supply voltage for the motor drive circuits 61, 62, 63, can be utilized as the backup for the motor drive circuits 61, 62, 63.

Next, with reference to FIG. 3, the switch control part 92 is described.

FIG. 3 is a diagram illustrating an example of a control system of the switch control part 92.

The switch control part 92 is connected to the first switch 20 and the second switch part 70 (i.e., the second switches 71, 72, 73).

In a first state in which the boost converter circuit 10 does not have an abnormality and the motor drive circuits 61 through 63 don't have an abnormality, the switch control part 92 forms a state in which the first switch 20 is closed, and the respective second switches 71 through 73 connect the multi-phase motor 3 to the midpoints of the second upper and lower arms 66 of the corresponding phases. Thus, in the first state, the switch control part 92 closes the first switch 20, and forms the state in which the second switch 71 connects the multi-phase motor 3 to the midpoint of the second upper and lower arms 66 related to U-phase, the second switch 72 connects the multi-phase motor 3 to the midpoint of the second upper and lower arms 66 related to V-phase and the second switch 73 connects the multi-phase motor 3 to the midpoint of the second upper and lower arms 66 related to W-phase. In the following, such a state of the first switch 20 and the second switches 71, 72, 73 is referred to as “step-up operable state”.

When the step-up operable state is formed, the output part 14 of the boost converter circuit 10 is connected to the second upper and lower arms 66 of motor drive circuits 61, 62, 63, respectively, via the second connection line 52. Thus, the boost converter circuit 10 can step up the supply voltage to be applied to the motor drive circuits 61, 62, 63.

In a second state in which the boost converter circuit 10 does not have an abnormality and the motor drive circuits 61 through 63 have an abnormality in a certain phase (any one phase), the switch control part 92 forms a state in which the first switch 20 is opened, and the second switch 71, or 73 related to the certain phase (i.e., the abnormal phase) connects the multi-phase motor 3 to the midpoint of the first upper and lower arms 12 (i.e., the motor drive line 50) while the other second switches (two second switches related phases free from the abnormality, among the second switches 71, 72, 73) connect the multi-phase motor 3 to the midpoints of the second upper and lower arms 66 of the corresponding phases. For example, in a state in which the boost converter circuit 10 does not have an abnormality and the motor drive circuit 61 related to U-phase, among the motor drive circuits 61 through 63, has an abnormality, the switch control part 92 forms a state in which the first switch 20 is opened, and the second switch 71 related to U-phase connects the multi-phase motor 3 to the midpoint of the first upper and lower arms 12 (i.e., the motor drive line 50) and the other second switches 72, 73 connect the multi-phase motor 3 to the second upper and lower arms 66 related to V-phase and W-phase, respectively. Further, in a state in which the boost converter circuit 10 does not have an abnormality and the motor drive circuit related to V-phase, among the motor drive circuits 62 through 63, has an abnormality, the switch control part 92 forms a state in which the first switch 20 is opened, and the second switch 72 related to V-phase connects the multi-phase motor 3 to the midpoint of the first upper and lower arms 12 (i.e., the motor drive line 50) and the other second switches 71, 73 connect the multi-phase motor 3 to the second upper and lower arms 66 related to U-phase and W-phase, respectively. Further, in a state in which the boost converter circuit 10 does not have an abnormality and the motor drive circuit 63 related to W-phase, among the motor drive circuits 63 through 63, has an abnormality, the switch control part 92 forms a state in which the first switch 20 is opened, and the second switch 73 related to W-phase connects the multi-phase motor 3 to the midpoint of the first upper and lower arms 12 (i.e., the motor drive line 50) and the other second switches 71, 72 connect the multi-phase motor 3 to the second upper and lower arms 66 related to U-phase and V-phase, respectively. In the following, such a state of the first switch 20 and the second switches 71, 72, 73 is referred to as “backup operable state”. Further, in the second state, the motor drive circuit related to the phase in which an abnormality is detected, among the motor drive circuits 61, 62, 63, is referred to as “the motor drive circuit related to the abnormal phase”, and the motor drive circuits other than the motor drive circuit related to the abnormal phase is referred to as “the motor drive circuits related to the normal phases”.

When the backup operable state is formed, the power supply voltage (not stepped up) of the power supply 4 is applied to the output part 14 of the boost converter circuit 10 via the first connection line 30. Thus, the power supply voltage of the power supply 4 is applied to the motor drive circuits 61, 62, 63, correspondingly. Further, the respective phases of the multi-phase motor 3 are connected to the boost converter circuit 10 and the motor drive circuits related to the normal phases, among the motor drive circuits 61, 62, 63. In such a connection state, the boost converter circuit 10 and the motor drive circuits related to the normal phases form the inverter circuit in cooperation. In other words, the first upper and lower arms 12 of the boost converter circuit 10 can function as an alternative (i.e., the backup) for the second upper and lower arms 66 of the motor drive circuit related to the abnormal phase.

In a third state in which the boost converter circuit 10 has an abnormality, the switch control part 92 forms a state in which the first switch 20 is opened, and the respective second switches 71 through 73 connect the multi-phase motor to the midpoints of the second upper and lower arms 66 of the corresponding phases. Thus, in the third state, the switch control part 92 opens the first switch 20, and forms the state in which the second switch 71 connects the multi-phase motor 3 to the midpoint of the second upper and lower arms 66 related to U-phase, the second switch 72 connects the multi-phase motor 3 to the midpoint of the second upper and lower arms 66 related to V-phase and the second switch 73 connects the multi-phase motor 3 to the midpoint of the second upper and lower arms 66 related to W-phase. In the following, such a state of the first switch 20 and the second switches 71, 72, 73 is referred to as “step-up disable state”.

When the step-up disable state is formed, the power supply voltage (not stepped up) of the power supply 4 is applied to the output part 14 of the boost converter circuit 10 via the first connection line 30. Thus, the power supply voltage of the power supply 4 is applied to the motor drive circuits 61, 62, 63, correspondingly.

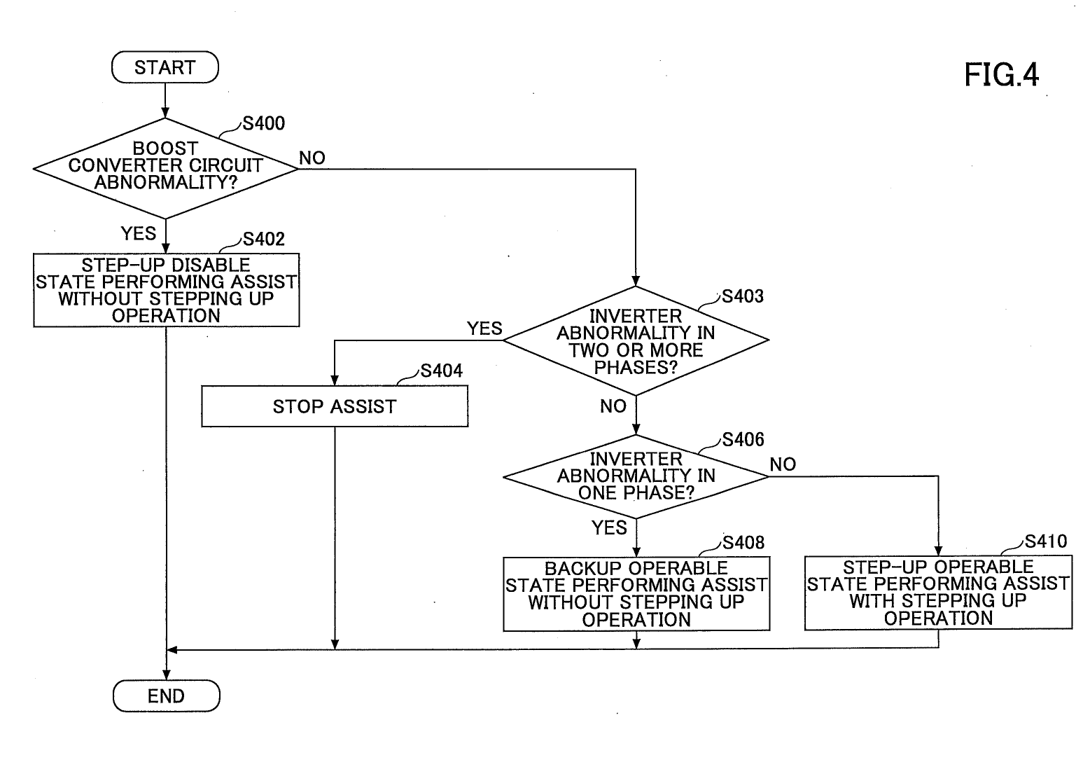

FIG. 4 is a flowchart illustrating an example of a process executed by the controller 9. The process illustrated in FIG. 4 may be performed repeatedly at a predetermined cycle, during an ON state of vehicle electric power or an ignition switch, for example.

In step S400, the switch control part 92 determines whether the boost converter circuit 10 has any abnormality. For example, the abnormality in the boost converter circuit 10 may be determined based on the detected value of the current sensor 80, the detected value of the output voltage at the output part 14, etc. The abnormality to be detected may be a short circuit failure, an open circuit failure, an intermediate adhesion failure, etc., of the switching elements Q1, Q2. If it is determined that the boost converter circuit 10 has any abnormality, the process routine goes to step S402, otherwise the process routine goes to step S403. It is noted that the switch control part 92 may set a flag (a boost converter circuit abnormality flag) indicative of the abnormality of the boost converter circuit 10. In this case, at the subsequent process cycles, the switch control part 92 refers to a state of the boost converter circuit abnormality flag to perform the determination in step S400.

In step S402, the switch control part 92 determines that the third state is detected, and thus the switch control part 92 forms the state (i.e., the step-up disable state) in which the first switch 20 is opened, and the respective second switches 71 through 73 connect the multi-phase motor 3 to the midpoints of the second upper and lower arms 66 of the corresponding phases. Thus, in the step-up disable state, the multi-phase motor 3 can still generate the assist torque based on the power supply voltage (not stepped up) of the power supply 4. In the step-up disable state, the motor drive control part 91 stops the switching elements Q1, Q2 of the boost converter circuit 10. Further, the motor drive control part 91 controls the switching elements Q3, Q4 of the second upper and lower arms 66 of the motor drive circuits 61, 62, 63, respectively, to generate the assist torque with the multi-phase motor 3, if necessary. It is noted that a way of controlling three pairs of the switching elements Q3, Q4 for generating the assist torque in the step-up disable state may be substantially the same as a way of controlling three pairs of the switching elements Q3, Q4 for generating the assist torque in the step-up operable state. It is noted that “substantially the same” means that these ways are the same in that the three-phase AC current is generated, but these ways may have differences in a target value, etc. For example, since the stepping up operation of the boost converter circuit 10 is not possible in the step-up disable state, the target value (for the output) of the multi-phase motor 3 in the step-up disable state may be generated by correcting the target value of the multi-phase motor 3 in the step-up operable state to a smaller value.

In step S403, the switch control part 92 determines whether the motor drive circuits 61, 62, have abnormalities in two or more phases. For example, this may be determined based on the detected values of the current sensors 82 related to the respective second upper and lower arms 66. The abnormality to be detected may be a short circuit failure, an open circuit failure, an intermediate adhesion failure, etc., of the switching elements Q3, Q4. If it is determined that the motor drive circuits 61, 62, 63 have abnormalities in two or more phases, the process routine goes to step S404, otherwise the process routine goes to step S406.

In step S404, the motor drive control part 91 stops the operations of the boost converter circuit 10 and motor drive circuits 61, 62, 63. In this case, the assist torque is not generated. At that time, the motor drive control part 91 may output the information for reporting the abnormality to the user. It is noted the information for reporting the abnormality may be outputted in step S402 and/or step S408. It is noted that when the process of step S404 is ended, the process routine in FIG. 4 may be ended.

In step S406, the switch control part 92 determines whether the motor drive circuits 61, 62, 63 have abnormalities in any one phase. For example, this may be determined based on the detected values of the current sensors 82 related to the respective second upper and lower arms 66. The abnormality to be detected may be a short circuit failure, an open circuit failure, an intermediate adhesion failure, etc., of the switching elements Q3, Q4. If it is determined that the motor drive circuits 61, 62, 63 have abnormalities in any one phase, the process routine goes to step S408, otherwise the process routine goes to step S410.

In step S408, the switch control part 92 determines that the second state is detected, and thus the switch control part 92 forms the state (i.e., the backup operable state) in which the first switch 20 is opened, and the second switch 71, 72 or 73 related to the abnormal phase connects the multi-phase motor 3 to the midpoint of the first upper and lower arms 12 (i.e., the motor drive line 50) and the other second switches (two second switches related phases free from the abnormality, among the second switches 71, 72, 73) connect the multi-phase motor 3 to the midpoints of the second upper and lower arms 66 of the corresponding phases. Thus, in the backup operable state, the multi-phase motor 3 can still generate the assist torque based on the power supply voltage (not stepped up) of the power supply 4. In the backup operable state, the motor drive control part 91 controls the switching elements Q1, Q2 of the first upper and lower arms 12 of the boost converter circuit 10, and the switching elements Q3, Q4 of the second upper and lower arms 66 of the motor drive circuits related to the normal phase, respectively, to generate the assist torque with the multi-phase motor 3, if necessary. It is noted that that a way of controlling the switching elements Q1, Q2 and two pairs of the switching elements Q3, Q4 for generating the assist torque in the backup operable state may be substantially the same as a way of controlling three pairs of the switching elements Q3, Q4 for generating the assist torque in the step-up operable state. Specifically, the switching elements Q1, Q2 may be controlled such that the switching elements Q3, Q4 of the second upper and lower arms 66 of the motor drive circuit related to the abnormal phase are replaced with the switching elements Q1, Q2. It is noted that “substantially the same” means that these ways are the same in that the three-phase AC current is generated, but these ways may have differences in a target value, etc. For example, since the stepping up operation of the boost converter circuit 10 is not possible in the backup operable state, the target value of the multi-phase motor 3 in the backup operable state may be generated by correcting the target value of the multi-phase motor 3 in the step-up operable state to a smaller value. It is noted that the target value of the multi-phase motor in the backup operable state may be the same as the target value of the multi-phase motor 3 in the step-up disable state.

In step S410, the switch control part 92 determines that the first state is detected, and thus the switch control part 92 forms the state (i.e., the step-up operable state) in which the first switch 20 is closed, and the respective second switches 71 through 73 connect the multi-phase motor to the midpoints of the second upper and lower arms 66 of the corresponding phases. In the step-up operable state, the motor drive control part 91 controls the switching elements Q1, Q2 of the boost converter circuit 10 to implement the stepping up operation, if necessary. Further, in the step-up operable state, the motor drive control part 91 controls the switching elements Q3, Q4 of the second upper and lower arms 66 of the motor drive circuits 61, 62, 63, respectively, to generate the assist torque with the multi-phase motor 3, if necessary.

According to the process illustrated in FIG. 4, in the first state in which the boost converter circuit 10 and the motor drive circuits 61, 62, 63 do not have any abnormality, the step-up operable state is formed, which enables increasing the output of the multi-phase motor 3. Further, in the second state in which the boost converter circuit 10 does not have any abnormality and any one phase of the motor drive circuits 61, 62, 63 has an abnormality, the backup operable state is formed so that the multi-phase motor 3 can still generate the assist torque based on the power supply voltage (not stepped up) of the power supply 4. Further, in the third state in which the boost converter circuit 10 has an abnormality, the step-up disable state is formed so that the multi-phase motor 3 can still generate the assist torque based on the power supply voltage (not stepped up) of the power supply 4.

It is noted that, in the process illustrated in FIG. 4, in the third state in which the boost converter circuit 10 has an abnormality, it is not determined whether the motor drive circuits 61, 62, 63 have any abnormality; however, such a determination may be performed. As a result of such a determination, when it is determined that at least one of the motor drive circuits 61, 62, 63 has any abnormality, the same process as step S404 may be performed.

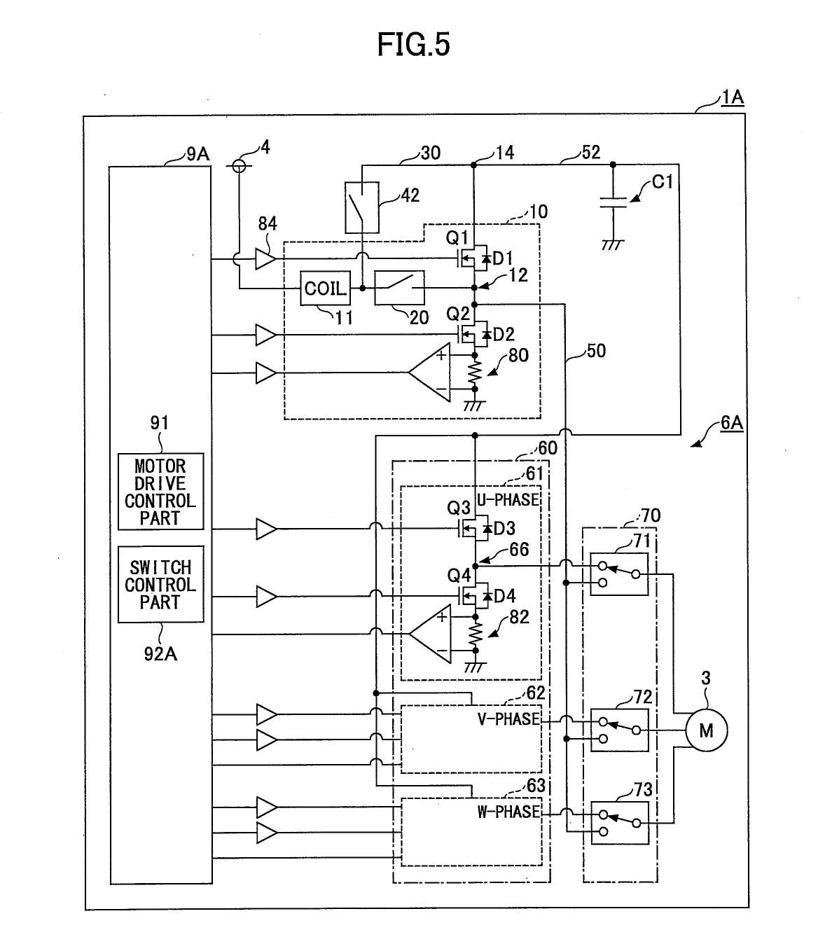

FIG. 5 is a diagram schematically illustrating a configuration of a system 1A including a motor drive apparatus 6A according to another example.

The motor drive apparatus 6A illustrated in FIG. 5 differs from the motor drive apparatus 6 illustrated in FIG. 1 mainly in that the diode 40 is replaced with a third switch 42 (another example of a limiting element), and the controller 9 is replaced with the controller 9A. The controller 9A differs from the controller 9 of the motor drive apparatus 6 in that the switch control part 92 is replaced with the switch control part 92A. Other components of the motor drive apparatus 6A may be substantially the same as those of the motor drive apparatus 6, and an explanation thereof is omitted, using the same reference numbers as used in FIG. 1 for these components in FIG. 5.

The third switch 42 may be a semiconductor switch or a mechanical relay. In the example illustrated in FIG. 1, the first switch 20 is a relay with a single arbeit contact.

The switch control part 92A has a function of controlling the third switch 42, in addition to the function of the switch control part 92 described above. Specifically, the switch control part 92A forms a state in which the third switch 42 is opened during the stepping up operation of the boost converter circuit 10 by the motor drive control part (during the first state described above, for example). With this arrangement, as is the case with the diode 40, the current from flowing in the reverse direction (i.e., the flow toward the power supply 4) at the time of the stepping up operation can be prevented. In the second state described above, the switch control part 92 forms a state in which the third switch 42 is closed. With this arrangement, in the backup operable state described above, the power supply voltage of the power supply 4 is applied to the motor drive circuits 61, 62, 63. In the third state described above, the switch control part 92 forms a state in which the third switch 42 is closed. With this arrangement, in the step-up disable state described above, the power supply voltage of the power supply 4 is applied to the motor drive circuits 61, 62, 63.

Also, according to the motor drive apparatus 6A illustrated in FIG. 5, the same effects as the motor drive apparatus 6 illustrated in FIG. 1 can be obtained. It is noted that the motor drive apparatus 6 illustrated in FIG. 1 is simple, compared to the motor drive apparatus 6A illustrated in FIG. 5, because the control of the third switch 42 by the switch control part 92A is not necessary.

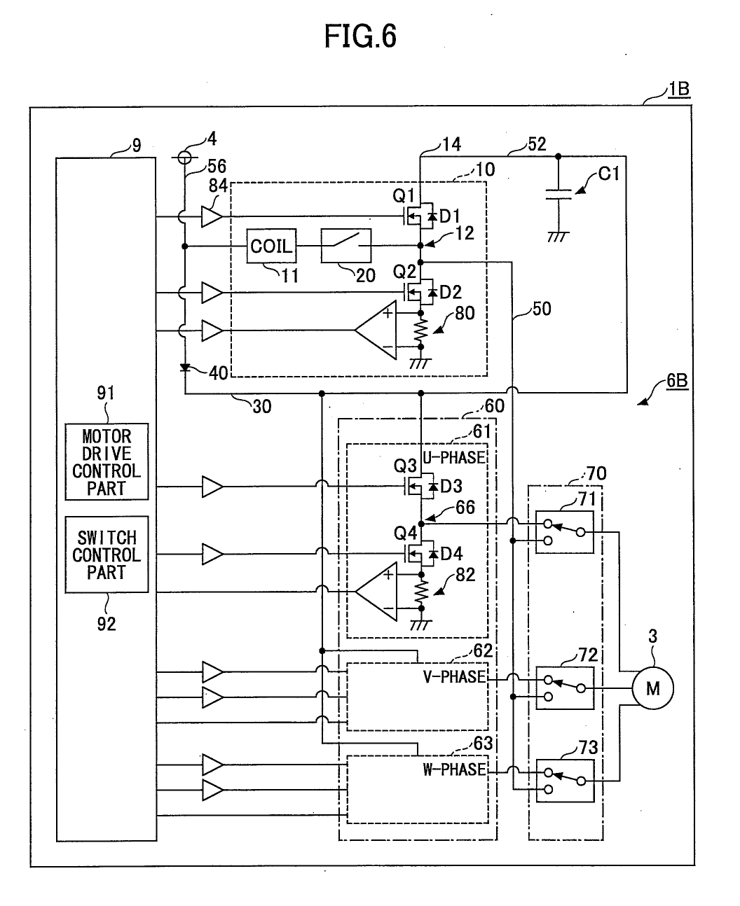

FIG. 6 is a diagram schematically illustrating a configuration of a system 1B including a motor drive apparatus 6B according to yet another example.

The motor drive apparatus 6B illustrated in FIG. 6 differs from the motor drive apparatus 6 illustrated in FIG. 1 mainly in that the first connection line 30 connects a point between the coil 11 and the power supply 4 to the output part 14 of the boost converter circuit 10. Specifically, in the motor drive apparatus 6 illustrated in FIG. 1, the first connection line 30 connects a point between the coil 11 and the first switch 20 to the output part 14 of the boost converter circuit 10, which in the motor drive apparatus 6B illustrated in FIG. 6, the first connection line 30 connects a point between the coil 11 and the power supply 4 to the output part 14 of the boost converter circuit 10.

Also, according to the motor drive apparatus 6B illustrated in FIG. 6, the same effects as the motor drive apparatus 6 illustrated in FIG. 1 can be obtained. The motor drive apparatus 6B illustrated in FIG. 6 has an advantage, compared to the motor drive apparatus 6 illustrated in FIG. 1, in that the coil 11 does not form a resistance component in the backup operable state and the step-up disable state. However, in the motor drive apparatus 6B illustrated in FIG. 6, a coil that serves as a filter may be provided in the first connection line 30.

It is noted that, also in the motor drive apparatus 6B illustrated in FIG. 6, the same variant as disclosed in FIG. 5 is possible. Specifically, also in the motor drive apparatus 6B illustrated in FIG. 6, replacements such as a replacement of the diode 40 with the third switch 42 (another example of a limiting element) are possible.

It is noted that, in the motor drive apparatus 6B illustrated in FIG. 6, the first connection line 30 is connected to the power supply 4 via a connection line 56 which is also used for the boost converter circuit 10; however, the first connection line 30 may be connected to the power supply 4 via a connection line which is not used for the boost converter circuit 10.

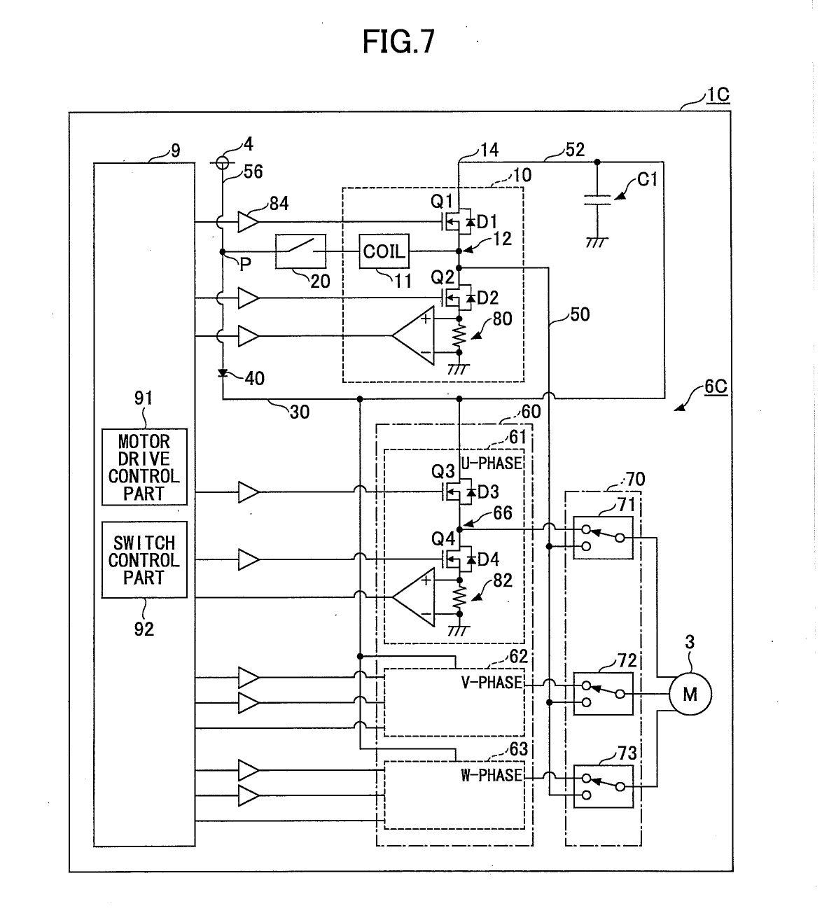

FIG. 7 is a diagram schematically illustrating a configuration of a system 10 including a motor drive apparatus 6C according to yet another example.

The motor drive apparatus 6C illustrated in FIG. 7 differs from the motor drive apparatus 6B illustrated in FIG. 6 in that the first switch 20 is closer to the power supply 4 than the coil 11. In this way, the first switch 20 may be provided at any location between the midpoint of the first upper and lower arms 12 of the boost converter circuit 10 and the power supply 4. However, according to the motor drive apparatus 6C illustrated in FIG. 7, as is the case with the motor drive apparatus 6 illustrated in FIG. 1, the first connection line 30 connects the power supply 4 to the output part 14 of the boost converter circuit 10 not via the first switch 20. In other words, the first switch 20 is provided between a connection point P of the first connection line 30, which is located on the side of the power supply 4, and the coil 11.

Also, according to the motor drive apparatus 6C illustrated in FIG. 7, the same effects as the motor drive apparatus 6 illustrated in FIG. 1 can be obtained. The motor drive apparatus 6C illustrated in FIG. 7 has an advantage, compared to the motor drive apparatus 6 illustrated in FIG. 1, in that the coil 11 does not form a resistance component in the backup operable state and the step-up disable state. However, in the motor drive apparatus 6C illustrated in FIG. 7, a coil that serves as a filter may be provided in the first connection line 30.

It is noted that, also in the motor drive apparatus 6C illustrated in FIG. 7, the same variant as disclosed in FIG. 5 is possible. Specifically, also in the motor drive apparatus 6C illustrated in FIG. 7, the replacements such as a replacement of the diode 40 with the third switch 42 (another example of a limiting element) are possible.

It is noted that, in the motor drive apparatus 6C illustrated in FIG. 7, the first connection line 30 is connected to the power supply 4 via a connection line 56 which is also used for the boost converter circuit 10; however, the first connection line 30 may be connected to the power supply 4 via a connection line which is not used for the boost converter circuit 10.

FIG. 8 is a diagram schematically illustrating a configuration of a system 1D including a motor drive apparatus 6D according to yet another example.

The motor drive apparatus 6D illustrated in FIG. 8 differs from the motor drive apparatus 6 illustrated in FIG. 1 in that the motor drive apparatus 6D has a circuit configuration for a vehicle drive apparatus that uses a high voltage. The switching elements Q1 through Q4 are IGBTs as power semiconductor elements, as illustrated in FIG. 8. Further, the system 1D illustrated in FIG. 8 differs from the system 1 illustrated in FIG. 1 in that the multi-phase motor 3 is replaced with a multi-phase motor 3D for driving the vehicle. Further, the system 1D illustrated in FIG. 8 differs from the system 1 illustrated in FIG. 1 in that the power supply 4 is replaced with a power supply 4D that includes a battery with a high voltage (greater than 100 V, for example). The multi-phase motor 3D generates a drive torque according to an accelerator position, etc., for example. In this case, the multi-phase motor 3D and the motor drive apparatus 6D form a vehicle drive apparatus. The vehicle drive apparatus can be installed on a hybrid vehicle and an electric vehicle.

It is noted that, in the example illustrated in FIG. 8, the current sensor 80 is provided on the motor drive line 50; however, this difference is not substantial. It is noted that the current sensors 80, 82 may be replaced with sense emitters included in the IGBT chips. A basic operation of the motor drive apparatus 6D illustrated in FIG. 8 is the same as that of the motor drive apparatus 6 illustrated in FIG. 1. The explanation described above can be applied to the switching elements Q1 through Q4 in FIG. 8 by replacing terms “drain” and “source” with terms “collector” and “emitter”, respectively.

Also, according to the motor drive apparatus 6D illustrated in FIG. 8, the same effects as the motor drive apparatus 6 illustrated in FIG. 1 can be obtained. It is noted that, also in the motor drive apparatus 6D illustrated in FIG. 8, the same variants as disclosed in FIG. 5 through FIG. 7 are possible.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention. Further, all or part of the components of the embodiments described above can be combined.

For example, in the example illustrated in FIG. 4, when the boost converter circuit 10 has an abnormality, the switch control part 92 forms the state (i.e., the step-up disable state) in which the first switch 20 is opened, and the respective second switches 71 through 73 connect the multi-phase motor to the midpoints of the second upper and lower arms 66 of the corresponding phases; however, a control way may be varied according to types of the abnormality in the boost converter circuit 10. For example, when the abnormality of the boost converter circuit 10 is an open circuit failure of the switching element Q2 of the lower arm, such a state may be formed in which the first switch 20 is closed, and respective second switches 71 through 73 connect the multi-phase motor 3 to the midpoints of the second upper and lower arms 66 of the corresponding phases. In this case, the motor drive control part may stop the operation of the boost converter circuit 10. In this case, the multi-phase motor 3 can still generate the assist torque based on the power supply voltage (not stepped up) of the power supply 4 via the diode D1 and the second connection line 52. In this case, the motor drive control part 91 controls the switching elements Q3, Q4 of the second upper and lower arms 66 of the motor drive circuits 61, 62, 63, respectively, to generate the assist torque with the multi-phase motor 3, if necessary.

What is claimed is:

1. A motor drive apparatus, comprising:
a boost converter circuit including a coil and first upper and lower arms, one end of the coil being connected to a midpoint of the first upper and lower arms, the other end of the coil being connected to a power supply;
a first switch provided between the midpoint of the first upper and lower arms and the power supply, the first switch being connected to the coil in series;
a first connection line connecting the power supply to an output part of the boost converter circuit without passing through the first switch;
a limiting element provided on the first connection line, the limiting element limiting a flow of a current from the output part of the boost converter circuit to the power supply;
a plurality of motor drive circuits provided for respective phases of a multi-phase motor, the motor drive circuits each including second upper and lower arms;
a second connection line connecting the output of the boost converter circuit to the respective second upper and lower arms of the motor drive circuits;
a plurality of second switches provided, for the respective phases of the multi-phase motor, between the second upper and lower arms of the corresponding phases and the multi-phase motor, the second switches each selectively connecting the multi-phase motor to either midpoints of the second upper and lower arms of the corresponding phases or the midpoint of the first upper and lower arms; and
a controller controlling the first switch and the second switches.

2. The motor drive apparatus of claim 1, wherein, in a first state in which the boost converter circuit does not have an abnormality and the motor drive circuits don't have an abnormality, the controller forms a state in which the first switch is closed, and the respective second switches connect the multi-phase motor to the midpoints of the second upper and lower arms of the corresponding phases.

3. The motor drive apparatus of claim 2, wherein, in the first state, the controller further implements a stepping up operation with the boost converter circuit while generating AC electrical power via the motor drive circuits, thereby driving the multi-phase motor.

4. The motor drive apparatus of claim 1, wherein, in a second state in which the boost converter circuit does not have an abnormality and the motor drive circuits have an abnormality in a certain phase, the controller forms a state in which the first switch is opened, and the second switch related to the certain phase connects the multi-phase motor to the midpoint of the first upper and lower arms while the other second switches connect the multi-phase motor to the midpoints of the second upper and lower arms of the corresponding phases.

5. The motor drive apparatus of claim 4, wherein, in the second state, the controller further generates AC electrical power via the first upper and lower arms of the boost converter circuit and the second upper and lower arms related to the phases, which are free from the abnormality, thereby driving the multi-phase motor.

6. The motor drive apparatus of claim 1, wherein, in a third state in which the boost converter circuit has an abnormality, the controller forms a state in which the first switch is opened, and the respective second switches connect the multi-phase motor to the midpoints of the second upper and lower arms of the corresponding phases.

7. The motor drive apparatus of claim 6, wherein, in the third state, the controller further stops an operation of the boost converter circuit while generating AC electrical power via the motor drive circuits, thereby driving the multi-phase motor.

8. The motor drive apparatus of claim 1, wherein the first connection line connects a point between the first switch and the coil to the output part of the boost converter circuit.

9. A power steering apparatus, comprising:
a multi-phase motor; and
a motor drive apparatus configured to drive the multi-phase motor to generate assist torque, wherein
the motor drive apparatus includes;
a boost converter circuit including a coil and first upper and lower arms, one end of the coil being connected to a midpoint of the first upper and lower arms, the other end of the coil being connected to a power supply;
a first switch provided between the midpoint of the first upper and lower arms and the power supply, the first switch being connected to the coil in series;
a first connection line connecting the power supply to an output part of the boost converter circuit without passing through the first switch;
a limiting element provided on the first connection line, the limiting element limiting a flow of a current from the output part of the boost converter circuit to the power supply;
a plurality of motor drive circuits provided for respective phases of a multi-phase motor, the motor drive circuits each including second upper and lower arms;
a second connection line connecting the output of the boost converter circuit to the respective second upper and lower arms of the motor drive circuits;
a plurality of second switches provided, for the respective phases of the multi-phase motor, between the second upper and lower arms of the corresponding phases and the multi-phase motor, the second switches each selectively connecting the multi-phase motor to either midpoints of the second upper and lower arms of the corresponding phases or the midpoint of the first upper and lower arms; and
a controller controlling the first switch and the second switches.
